(19) United States
(12) Patent Application Publication
(10) Pub. No.: US 2007/0239879 A1
(43) Pub. Date: Oct. 11, 2007

(54) METHOD AND APPARATUS FOR ROUTER RECOVERY

(75) Inventors: YETIK SERBEST, AUSTIN, TX (US); ALAN WENGE CHEN, AUSTIN, TX (US); STEPHANIE KARASICK, AUSTIN, TX (US); ERIC PUETZ, GEORGETOWN, TX (US)

Correspondence Address: AKERMAN SENTERFITT, P.O. BOX 3188, WEST PALM BEACH, FL, 33402-3188, US

(73) Assignee: SBC KNOWLEDGE VENTURES, L.P., RENO, NV (US)

(21) Appl. No.: 11/279,231

(22) Filed: Apr. 10, 2006

(51) Int. Cl. G06F 15/16

(52) U.S. Cl. 709/230

(57) ABSTRACT

An apparatus and method are disclosed for router recovery. A system that incorporates teachings of the present disclosure may include, for example, a designated router (DR) (108) having a controller programmed to detect (308) a querier router (QR) (110) routing content to gateways (114) by way of a LAN (112), transmit a notice message to the QR and the LAN announcing the DR's presence, transmit a (310) query message on the LAN, receive (312) from a gateway a first request for content in response to the query message, transmit (314) to a data center a second request for the content, transmit (320, 326) the content received from the data center to the gateway thereby prompting the QR to cease (324, 338) transmitting content to said gateway, and repeat (340) a portion of the foregoing steps until the QR relinquishes transmission of content to said gateways. Additional embodiments are disclosed.

### FIELD OF THE DISCLOSURE

The present disclosure relates generally to routers, and more specifically to a method and apparatus for router recovery.

### BACKGROUND

Broadband communications has brought new applications such as IPTV services to residential and commercial users. Such users have an expectation that these services will be available at all times without interruption. To satisfy this need, network elements such as routers delivering such services must be designed for reliability.

A need therefore arises for a router recovery method and apparatus.

### BRIEF DESCRIPTION OF THE DRAWINGS

FIG. 1 depicts an exemplary embodiment of a communication system supporting Internet Protocol TV (IPTV) services;

FIGS. 2-3 depict an exemplary method operating in portions of a designated router (DR) and querier router (QR) that illustrates how the QR acquires content control from the DR after it experiences an outage and thereafter gradually relinquishes control back to the DR after it has recovered from the outage; and

FIG. 4 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a method and apparatus for router recovery.

In a first embodiment of the present disclosure, a designated router (DR), can have a controller programmed to detect a querier router (QR) routing content to a plurality of gateways by way of a local area network (LAN), transmit a notice message to the QR and the LAN announcing the DR's presence, transmit a query message on the LAN, receive from a select one of the gateways a first request for content in response to the query message, transmit to a data center a second request for the content requested by the select one of the gateways, transmit the content received from the data center to the select one of the gateways thereby prompting the QR to cease transmitting content to said gateway, and repeat a portion of the foregoing steps until the QR relinquishes transmission of content to said gateways.

In a second embodiment of the present disclosure, a Querier router (QR) can have a controller programmed to detect an outage of a designated router (DR) that routes content to a plurality of gateways by way of a local area network (LAN), transmit to a data center a request for the content routed by the DR, transmit the content received from the data center to the gateways, detect a notice message from the DR indicating that it has recovered from the outage, detect a request for content transmitted by a select one of the gateways to the DR, cease transmitting content to the select one of the gateways in response to the detected request, and repeat a portion of the foregoing steps for as long as one or more of the gateways transmit a request for content to the DR.

In a third embodiment of the present disclosure, a computer-readable storage medium in a designated router (DR) can have computer instructions in which the DR gradually accepts control of content transmitted by a querier router (QR) to a plurality of gateways.

In a fourth embodiment of the present disclosure, a computer-readable storage medium in a querier router (QR) can have computer instructions for gradually relinquishing control to a designated router (DR) of content transmitted by the QR to a plurality of gateways.

In a fifth embodiment of the present disclosure, a computer-readable storage medium in a residential gateway (RG) can have computer instructions for detecting a query message from a designated router (DR) which is gradually accepting control of content transmitted by a querier router (QR) to the RG.

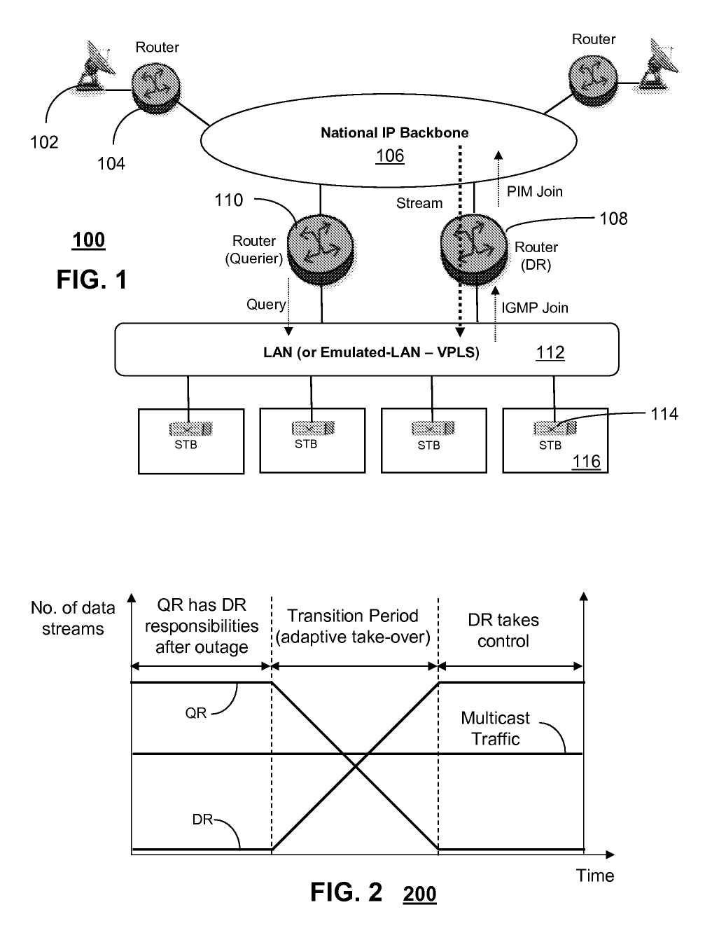

FIG. 1 depicts an exemplary embodiment of a communication system 100 supporting Internet Protocol TV (IPTV) services. The communication system 100 comprises an IPTV services infrastructure composed of satellite receivers 102 and a corresponding router 104 coupled to a backbone 106. The backbone 106 (herein referred to as backbone 106) serves as a national aggregation data center for many types of consumer programming (e.g., ABC, NBC, CBS, ESPN, CSPAN, CNN, HBO, Showtime, etc.). This content is in turned delivered to video hub offices (VHOs) that serve metropolitan areas with the addition of local channels.

In metropolitan areas, two routers, a designated router (DR) 108 and querier router (QR) 110) are used to deliver the VHO channels to gateways 114 located in a residence or commercial enterprise 116 over a local area network (LAN) or emulated LAN such as a virtual private LAN service (VPLS) 112. The gateways 114 can be represented by a common residential gateway or set top box (STB). For illustration purposes only, the gateway will be referred to as an STB 114. It would be evident to an artisan with ordinary skill in the art, however, that other configurations are possible within the scope of the claims described below.

The DR 108 and QR 110 utilize common controller technology such as one or more microprocessors and/or digital signal processors that manage volatile and/or non-volatile memories and communication interfaces for routing frames, packets or cells in the communication system 100. The DR 108 and QR 110 serve as a redundant system for delivering content to the STBs 114. The DR 108 acts as the primary delivery system of content to the STBs 114, while the QR 110 is a backup system to the DR. In normal operation, the DR 108 can receive content requests from the STBs 114 in the form of Internet Group Management Protocol (IGMP) join messages. The IGMP join messages identify the channels of interest for the end user directing the STB 114. The DR 108 in turn submits a request for the requested channels to the backbone 106 in the form of a protocol independent multicast (PIM) join message. The backbone 106 in response provides a multicast stream of content (or unicast stream of content for on-demand programming) to the DR 108 which relays said content to the requesting STB 114 by way of the LAN 112.

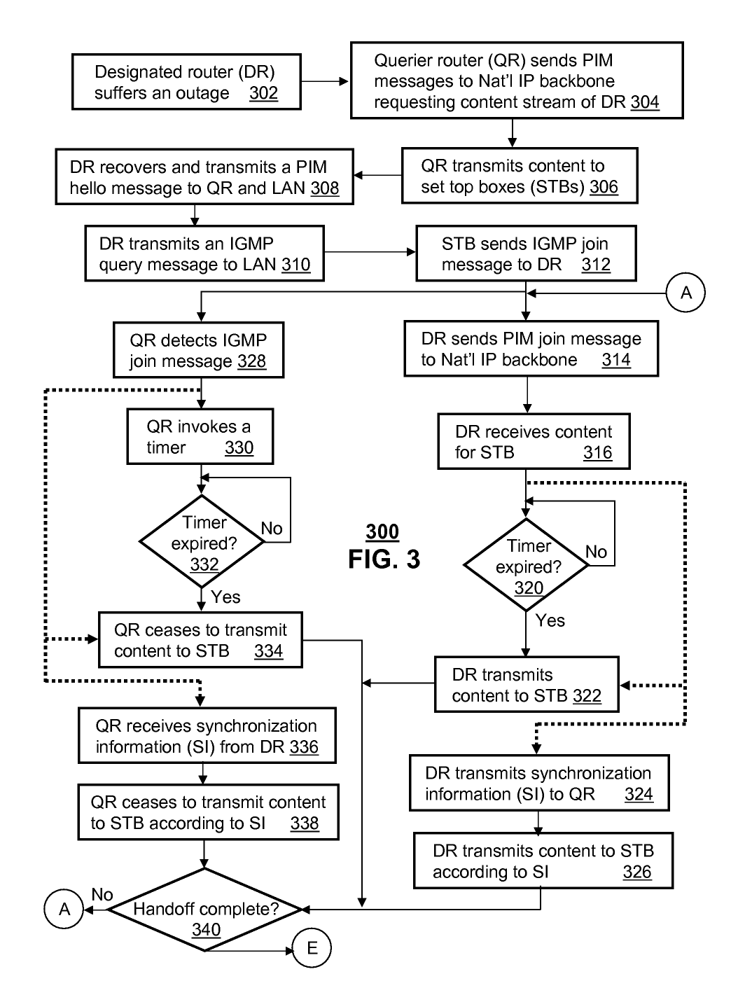

The QR 110 submits periodic IGMP query messages to maintain a copy of the multicast (and/or unicast) states stored in the DR 108. FIGS. 2-3 depict an exemplary method 300 operating in portions of the DR 108 and QR 110 that illustrates how the QR 110 acquires content control from the DR 108 after it experiences an outage and thereafter gradually relinquishes control back to the DR 108 after it has recovered from the outage.

Method 300 begins with step 302 in which the DR 108 suffers an outage. The outage can be due to a hardware, software, or other common failure condition which places the DR 108 out of service. The QR 110 detects the outage in step 304 using common techniques and sends PIM messages to the backbone 106 requesting the content stream previously relayed by the DR 108 to the STBs 114. Since the QR 110 knows the current multicast (and/or unicast) states prior to the outage, it need not send an IGMP query message to the STBs 114. Once the QR 110 receives the multicast and/or unicast content streams from the backbone 106, it transmits said streams in step 306 to the STBs 114. During the transition period between steps 302-306 the STBs 114 can experience an outage of 3-5 seconds.

Once the DR 108 recovers in step 308, it transmits a PIM hello notice message to the QR 110 and the LAN 112 thereby informing the QB 110 and the STBs 114 that the DR 108 is back on line. The DR 108 then transmits in step 310 an IGMP query message to the LAN 112. Upon detecting this message, each STB 114 responds in step 312 with an IGMP join message which identifies the programming channels of interest to said STB. In response to the IGMP join message, parallel activities occur at the DR 108 and the QR 110 as shown by steps 314-326 and steps 328-340, respectively.

Beginning with step 314, the DR 108 responds to the IGMP join message by transmitting a PIM join message to the backbone 106. The DR 108 receives the requested content for the STB 114 in step 316 from the backbone 106. From this point, the DR 108 can proceed according to any one of three embodiments. In a first embodiment, the DR 108 checks for the expiration of a timer in step 320 which was concurrently invoked by the QR 110 in step 330 after detecting in step 328 the IGMP join message of the STB 114 in step 312. The timer can be set to a time greater than the time known for the DR 108 to receive the requested content from the backbone 106. Consequently, there will be a small period of time when both the DR 108 and the QR 110 are receiving duplicate streams of content for the requesting STB 114. Upon expiration of the timer in steps 320 and 332, the DR 108 begins to transmit content in step 322 to the STB 114, and the QR 11O ceases to transmit the same content in step 334. The STB 114 sees no interruption in the data stream during this transition.

In an alternative embodiment, the DR 108 can be programmed to proceed to step 324 where it transmits synchronization information to the QR 110, which the QR receives in step 336. The synchronization information can define, for example, a packet number or queue state at which the handover between the QR 110 and the DR 108 is to take place. In accordance with the synchronization information, a handoff takes place between the QR 110 and the DR 108 in steps 338 and 326. As in the previous embodiment, there can also be a moment in time where both the DR 108 and the QR 110 are receiving duplicate streams of content. However, when the transition takes place, no interruption is experienced by the STB 114.

In yet another embodiment, the DR 108 can be programmed to transmit content to the STB 114 as soon as it arrives from the backbone 106, while the QR 110 relinquishes transmission upon detecting the IGMP join message from the STB. In this embodiment there may be a very short period of time where there is a content interruption (e.g., milliseconds) which would likely not be noticeable to an end user of the STB 114 while viewing a particular program. The benefit of this embodiment is that it avoids duplication of content streams between the DR 108 and the QR 110.

For each of the foregoing embodiments, step 340 is invoked by the DR 108 and the QR 110. In this step, a determination is made whether all of the STBs 114 are being serviced by the DR 108. If they are not, then steps 314-338 are repeated.

Method 300 thus describes a process in which the DR 108 and the QR 110 gradually handoff content between each other as each STB 114 responds with an IGMP join message. This process illustrates a recovery method for the DR 108 that is substantially less interruptive to the STBs 114 than prior art systems. This point can be illustrated in FIG. 2. In FIG. 2 when a DR 108 experiences an outage, the QR 110 takes over as described earlier by method 300. Upon a DR 108 recovery, a transition period occurs in which the QR 110 gradually relinquishes content transmissions to the DR 108 as described earlier. As a result of this transition period, the multicast traffic is uninterrupted or minimally interrupted by the handoff.

In prior art systems, the QR 110 relinquishes control upon receiving a PIM hello from the DR 108. By the time the DR 108 receives multicast and/or unicast updates from the STBs 114, sends corresponding PJM joins to the backbone 106, receives the content and transmit it to the STBs, service can be interrupted between 18 to 25 seconds. The present disclosure provides embodiments with no interruption or a nominal interruption of less than one second.

It would be evident to an artisan with ordinary skill in the art that the aforementioned embodiments can be modified, reduced, or enhanced without departing from the scope and spirit of the claims described below. The reader is therefore directed to the claims for a fuller understanding of the breadth and scope of the present disclosure.

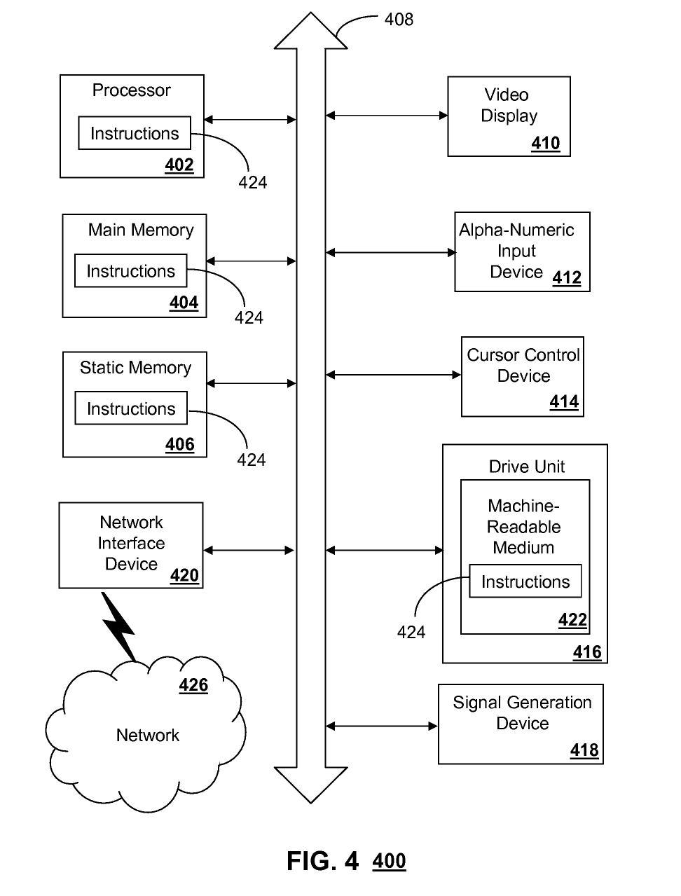

FIG. 4 depicts an exemplary diagrammatic representation of a machine in the form of a computer system 400 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 400 may include a processor 402 (e.g., a central processing unit (CPU), a graphics processing unit (GPU, or both), a main memory 404 and a static memory 406, which communicate with each other via a bus 408. The computer system 400 may further include a video display unit 410 (e.g., a liquid crystal display (LCD), a flat panel, a solid state display, or a cathode ray tube (CRT)). The computer system 400 may include an input device 412 (e.g., a keyboard), a cursor control device 414 (e.g., a mouse), a disk drive unit 416, a signal generation device 418 (e.g., a speaker or remote control) and a network interface device 420.

The disk drive unit 416 may include a machine-readable medium 422 on which is stored one or more sets of instructions (e.g., software 424) embodying any one or more of the methodologies or functions described herein, including those methods illustrated above. The instructions 424 may also reside, completely or at least partially, within the main memory 404, the static memory 406, and/or within the processor 402 during execution thereof by the computer system 400. The main memory 404 and the processor 402 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 424, or that which receives and executes instructions 424 from a propagated signal so that a device connected to a network environment 426 can send or receive voice, video or data, and to communicate over the network 426 using the instructions 424. The instructions 424 may further be transmitted or received over a network 426 via the network interface device 420.

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A designated router (DR), comprising a controller programmed to:
detect a querier router (QR) routing content to a plurality of gateways by way of a local area network (LAN);
transmit a notice message to the QR and the LAN announcing the DR's presence;
transmit a query message on the LAN;
receive from a select one of the gateways a first request for content in response to the query message;
transmit to a data center a second request for the content requested by the select one of the gateways;
transmit the content received from the data center to the select one of the gateways thereby prompting the QR to cease transmitting content to said gateway; and
repeat a portion of the foregoing steps for as long as one or more of the gateways transmit a request for content to the DR.

2. The DR of claim 1, wherein the notice message comprises a protocol independent multicast (PIM) message.

3. The DR of claim 1, wherein the first request comprises an Internet Group Management Protocol (IGMP) message.

4. The DR of claim 1, wherein the second request comprises a protocol independent multicast (PIM) message.

5. The DR of claim 1, wherein the controller is programmed to transmit synchronization information to the QR for each gateway that the DR receives the first request, thereby prompting the QR to cease transmitting content to each of said gateways according to its corresponding synchronization information.

6. The DR of claim 1, wherein the controller is programmed to transmit the content received from the data center to the select one of the gateways upon expiration of a timer invoked by at least one among the QR and the DR.

7. The DR of claim 1, wherein the content routed to the gateways conforms to at least one among unicast traffic and multicast traffic.

8. The DR of claim 1, wherein the first request comprises a multicast state for the select one of the gateways.

9. The DR of claim 1, wherein a gateway comprises at least one among a residential gateway and a set top box (STB), and wherein the LAN comprises a virtual private LAN service (VPLS).

10. A Querier router (QR), comprising a controller programmed to:
detect an outage of a designated router (DR) that routes content to a plurality of gateways by way of a local area network (LAN);
transmit to a data center a request for the content routed by the DR;
transmit the content received from the data center to the gateways;
detect a notice message from the DR indicating that it has recovered from the outage;
detect a request for content transmitted by a select one of the gateways to the DR;
cease transmitting content to the select one of the gateways in response to the detected request; and
repeat a portion of the foregoing steps until each of the gateways have transmitted to the DR a request for content.

11. The QR of claim 10, wherein the notice message comprises a protocol independent multicast (PIM) message.

12. The QR of claim 10, wherein the request comprises an Internet Group Management Protocol (IGMP) message.

13. The QR of claim 10, wherein the controller is programmed to:
receive synchronization information from the DR for each gateway for which the DR receives the request; and
cease transmitting content to each of said gateways according to its corresponding synchronization information.

14. The QR of claim 10, wherein the controller is programmed to:
enable a timer upon detecting the request for the select one of the gateways; and
cease transmitting content to the select one of the gateways upon expiration of the timer.

15. The QR of claim 10, wherein the content routed to the gateways conforms to at least one among unicast traffic and multicast traffic.

16. The QR of claim 10, wherein the request comprises a multicast state for the select one of the gateways.

17. The QR of claim 10, wherein the LAN comprises a virtual private LAN service (VPLS).

18. A computer-readable storage medium in a designated router (DR), comprising computer instructions in which the DR gradually accepts control of content transmitted by a querier router (QR) to a plurality of gateways.

19. The storage medium of claim 18, comprising computer instructions for accepting content gradually as each gateway recognizes the DR.

20. The storage medium of claim 18, comprising computer instructions for coordinating between the QR and the DR a handoff of the content transmitted to the gateways according to one among a timer initiated by the QR and synchronization information transmitted to the QR.

21. A computer-readable storage medium in a querier router (QR), comprising computer instructions for gradually relinquishing control to a designated router (DR) of content transmitted by the QR to a plurality of gateways.

22. The storage medium of claim 21, comprising computer instructions for relinquishing content gradually as each gateway recognizes the DR.

23. The storage medium of claim 20, comprising computer instructions for coordinating between the QR and the DR a handoff of the content transmitted to the gateways according to one among a timer initiated by the QR and synchronization information transmitted by the DR to the QR.

24. A computer-readable storage medium in a residential gateway (RG), comprising computer instructions for detecting a query message from a designated router (DR) which is gradually accepting control of content transmitted by a querier router (QR) to the RG.
